(19) United States
(12) Patent Application Publication
(10) Pub. No.: US 2012/0311427 A1
(43) Pub. Date: Dec. 6, 2012

(54) INSERTING A BENIGN TAG IN AN UNCLOSED FRAGMENT

(76) Inventors: GERHARD DIETRICH KLASSEN, Waterloo (CA); George Ross Staikos, Toronto (CA); Prakash Damodaran, South Grafton, MA (US); Eli Joshua Fidler, Toronto (CA)

(21) Appl. No.: 13/118,702

(22) Filed: May 31, 2011

(51) Int. Cl. G06F 17/00

(52) U.S. Cl. 715/234

(57) ABSTRACT

A device receives data to be rendered. A fragment in the data that is unclosed is detected, and a benign tag is inserted in the unclosed fragment to cause a rendering engine to render the unclosed fragment.

### BACKGROUND

Electronic devices can receive content that is to be rendered for display. The received content can include electronic mail messages, web pages, social networking messages, or other content. A rendering engine of the electronic device is used to parse and layout the received content to produce an output that is capable of being displayed on a display device.

When a user attempts to view received content, such as by opening an electronic mail message, the rendering engine attempts to render the received content. In some cases, the content delivered to the electronic device is partial content, which may not properly be rendered by the rendering engine. In other cases, the content delivered to the electronic device can include a long segment that may take a while (e.g. a few seconds) to parse—during such parsing, nothing is shown by the rendering engine.

### BRIEF DESCRIPTION OF THE DRAWINGS

Some embodiments are described with respect to the following figures:

FIG. 1 is a block diagram of an example arrangement incorporating some embodiments;

FIG. 2 is a flow diagram of a procedure to process an unclosed fragment of data, in accordance with some embodiments;

FIGS. 3, 4, and 6 illustrate examples of unclosed fragments;

FIG. 5 is a flow diagram of a procedure to process an unclosed fragment, according to further embodiments; and

FIG. 7 is a flow diagram of a procedure to insert a benign tag, according to some embodiments.

### DETAILED DESCRIPTION

Rendering engines can be provided in electronic devices to parse and render content according to various defined formats. One example format is the HTML (Hypertext Markup Language) format, which is often used in electronic mail messages or web pages. Other formats can be used in other examples.

With HTML content (or content according to other markup languages), tags are used to assist a rendering engine (sometimes also referred to as a layout engine) in interpreting the content. Tags are elements used for annotating content (which can include text, images, and so forth). The tags can define the structure of the content (e.g., section heading, paragraph, title, line break, etc.) or an attribute of the content (font, color, style, etc.). Tags can also provide other instructions or definitions of content. Tags include opening tags and closing tags, where a pair of an opening tag and a closing tag defines an element, such as a text element, image element, or other element.

In certain scenarios, an electronic device may receive partial content from another device. For example, an electronic mail server device may deliver just a first portion of an electronic mail message to a client device, such as in cases where the content of the electronic mail message exceeds a certain size. As a result, the received partial content can include a fragment that contains an opening tag but that is missing a corresponding closing tag. Such a fragment is an example of an “unclosed fragment.”

Some rendering engines may be unable to properly render unclosed fragments. Upon receipt of an unclosed fragment, the unclosed fragment is not displayed as the client device awaits further content to be received. Thus, when a user attempts to open the partial content (such as a partial electronic mail message), the unclosed fragment is depicted as blank content until further content that contains the closing tag is received. In some cases, the further content may not be delivered until a user performs an action to request more content.

In other scenarios, a client device may receive content that includes a relatively long text element (or other type of element). As the relatively long text segment is received by the client device, the parser of the rendering engine may take a relatively long time (e.g., a few seconds) to parse the long text element. While the rendering engine is parsing the text element, the user may see a blank portion where the text element is supposed to have been rendered. This can have a relatively jarring effect on the user when the user is initially retrieving content, such as opening an electronic mail message or other content. A relatively long element (such as a text element) that is in the process of being parsed by a rendering engine is also referred to as an “unclosed fragment.”

More generally, an “unclosed fragment” refers to any portion of content that is to be rendered on a client device, where the portion does not contain a closing tag that corresponds to an opening tag in the portion. The portion can be partial content sent by a server device to a client device, where the partial content is missing further data not yet sent by the server device until a further event occurs, such as when a request for more content is submitted by the client device. The portion can also be part of full content that has been received by the client device, but the portion has a length that exceeds some predefined length threshold that can result in delay in display of the portion while the portion is being parsed by a rendering engine.

In accordance with some embodiments, to allow for proper display of an unclosed fragment in received data, a “benign tag” is inserted into the unclosed fragment. A “benign tag” (which can also be referred to as a “dummy tag”) refers to a tag that has no operational meaning to the rendering engine. In other words, from the perspective of the rendering engine, the benign tag (or dummy tag) is not a tag defined by the respective standard or protocol and thus does not provide any instruction to the rendering engine regarding how to render received content. In implementations where the content is defined by a markup language such as HTML, the benign tag is a tag not defined by the markup language.

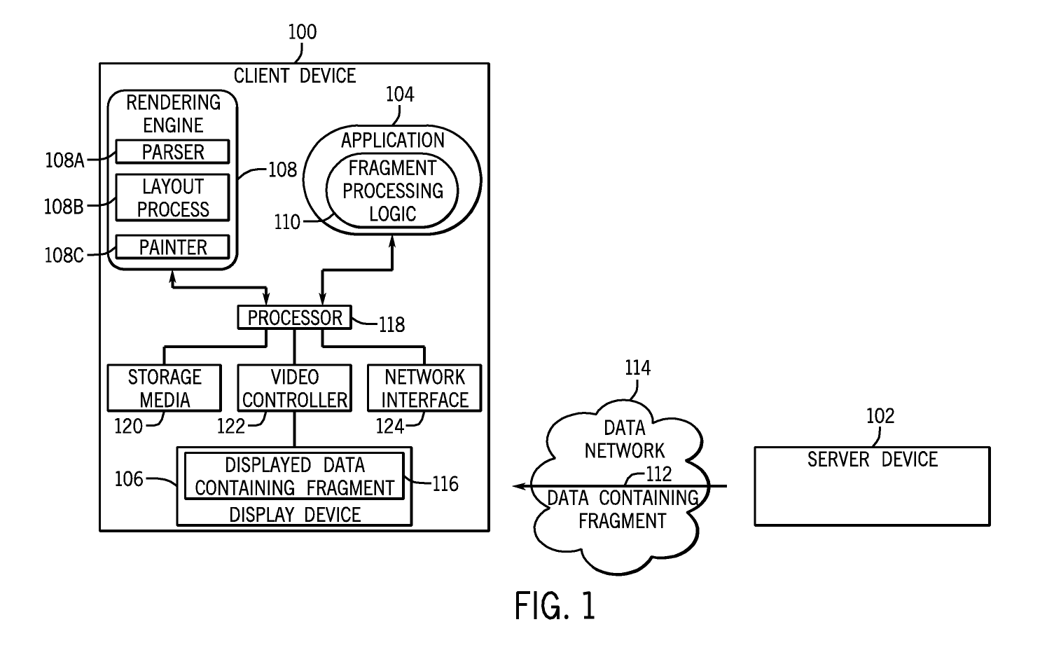

FIG. 1 is a block diagram of an example network arrangement that includes a client device 100 and a server device 102. Although just one client device 100 is shown in FIG. 1, it is noted that a typical network arrangement would include multiple client devices 100 that are able to communicate with the server device 102. Note also that there can be multiple server devices 102. Although reference is made to a “client device” and “server device” in the discussion herein, it is noted that techniques or mechanisms according to some implementations can be embodied in any type of electronic device that is used to render content received by the electronic device.

Examples of the client device 100 include a computer (e.g. desktop computer, notebook computer, tablet computer, and so forth), a personal digital assistant (PDA), a mobile telephone, an electronic appliance or other type of electronic device.

The server device 102 can be any electronic device that is able to communicate data to the client device 100. Examples of the server device 102 include an electronic mail server (that communicates electronic mail messages to client devices), a web server device, a proxy device, and so forth. The server device 102 can be implemented with a server computer or a system having multiple server computers, as examples.

The client device 100 includes an application 104 which is able to receive data from the server device 102 and to display the data on a display device 106 of the client device 100. For example, the application 104 can be an electronic mail application to present electronic mail messages in the display device 106 of the client device 100. In other implementations, the application 104 can be a web browser (to display web content), a social networking application (to display social networking messages), or any other type of application that allows a user of the client device 100 to view content in the display device 106.

The client device 100 also includes a rendering engine 108 that processes content received by the application 104 to allow the received data to be displayed in the display device 106. In some implementations, the content is defined by a markup language such as HTML. In some examples, the rendering engine 108 can include a parser 108A to parse received content, a layout process 1088 to place various nodes representing different parts of the received content in a layout as the respective parts of the content would appear in a display, and a painter 108C to paint the content according to the layout specified by the layout process 1088.

In some examples, the rendering engine 108 can be a WebKit rendering engine, which is an open source rendering engine used for rendering web pages. In other implementations, the rendering engine 108 can be another type of rendering engine.

In accordance with some embodiments, the application 104 contains fragment processing logic 110, which is able to process a received unclosed fragment to allow for proper display of the unclosed fragment. Although the fragment processing logic 110 is depicted as being part of the application 104, it is noted that in alternative implementations, the fragment processing logic 110 can be external to the application 104, but can be invoked by the application 104 to process unclosed fragments in accordance with some embodiments.

As shown in FIG. 1, the server device 102 sends data (112) containing a fragment, such as an unclosed fragment as explained above. The data 112 containing the fragment is sent by the server device 102 to the client device 100 over a data network 114, which can be a private network (e.g. local area network, wide area network, etc.) or a public network (e.g. the Internet). The fragment processing logic 110 in the client device 100 processes the data 112 containing the fragment. The fragment processing logic 110 is able to add benign tags where appropriate in the received fragment to allow the received fragment to be properly displayed at 116 in the display device 106.

As further shown in FIG. 1, the client device 100 includes a processor (or multiple processors) 118. The processor(s) 118 is (are) connected to storage media 120, a video controller 122, and a network interface 124. The video controller 122 is connected to the display device 106 to control the display of data in the display device 106. Examples of the storage media 120 include one or multiple disk-based storage devices, one or more integrated circuit storage devices, and so forth. The network interface 124 allows the client device 100 to communicate over the data network 114.

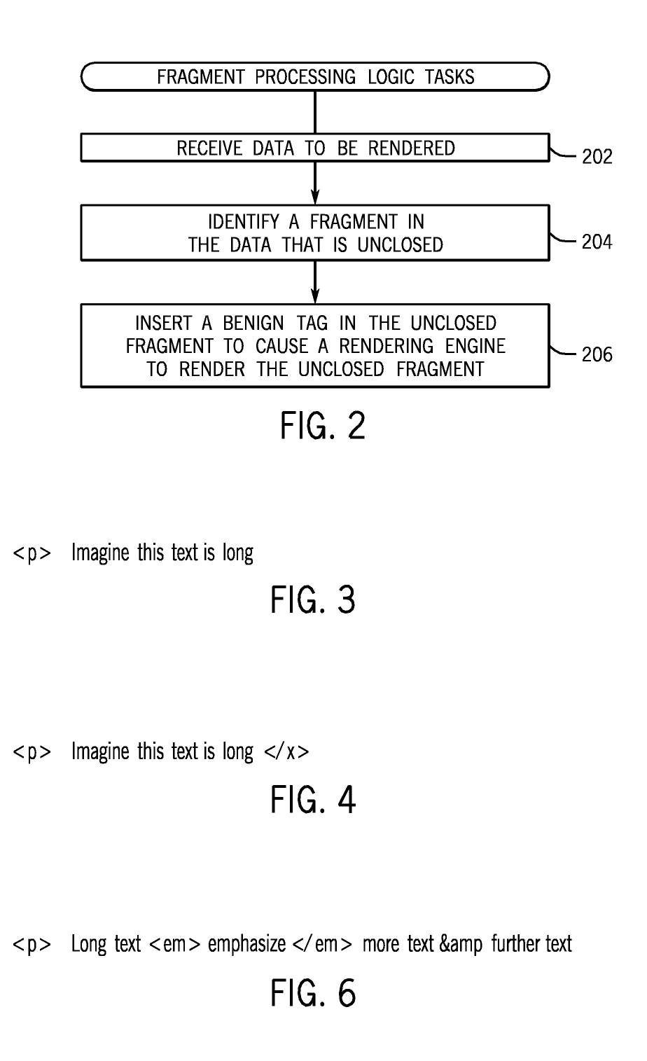

FIG. 2 is a flow diagram of a process performed by the fragment processing logic 110 according to some implementations. The fragment processing logic 110 receives (at 202) data to be rendered. The received data can be a document, such as a file according to a markup language.

Next, the fragment processing logic identifies (at 204) a fragment in the data that is unclosed. Identifying a portion of received data as being an unclosed fragment can be in response to determining that a condition is satisfied. The condition can be that an indication has been received by the fragment processing logic 110 that the received data is partial data that is missing further data not yet sent by the server device 102. Such indication of partial data can be indicated by a “more” break, which is an indication that there is further data not yet sent by the server device 102. The further data is not sent by the server device 102 until the client device 100 sends a request for the further data, such as in response to user action at the client device 100 (e.g. user selecting a selectable link or icon or performing another action to request that the further data be sent).

Alternatively, another condition indicating that the portion of the received data should be identified as an unclosed fragment is that the portion has a length (e.g. expressed as a number of text characters) that exceeds a length threshold. A data portion having a length that exceeds the length threshold may take a while (e.g. several seconds) for the parser 108A of the parsing engine 108 to parse, during which time the data portion cannot be rendered by the rendering engine 108.

If an unclosed fragment is identified, then the fragment processing logic 110 inserts (at 206) a benign tag in the unclosed fragment to cause a rendering engine to render the unclosed fragment. Note that the insertion of the benign tag is at a position that is not within another tag or an entity (discussed further below).

FIG. 3 shows an example of an unclosed fragment. The tag <p> (which is an opening tag) indicates that the element following such tag is a paragraph. In FIG. 3, the element following the paragraph tag <p> is a long text. Note that there is no closing tag corresponding to the opening tag, <p>, in the fragment shown in FIG. 3. A closing paragraph tag would have been represented as </p>.

In some implementations, the unclosed fragment depicted in FIG. 3 would not be properly rendered by the rendering engine 108 for display. However, in accordance with some implementations, a benign tag can be added to the unclosed fragment of FIG. 3 (task 206 in FIG. 2), to result in the fragment shown in FIG. 4. The benign tag in the example of FIG. 4 is represented as </x>. In other examples, other forms of benign tags can be used; the only consideration is that the benign tag should not be an actual tag that is recognized by the rendering engine 108.

In response to detecting presence of the benign tag, </x>, the rendering engine 108 processes the fragment shown in FIG. 4 to render the text between the tag <p> and the benign tag </x>. Since the benign tag </x> is not recognized by the rendering engine 108, the rendering engine 108 can simply discard the benign tag. No visible changes in the appearance of the fragment occur as a result of the benign tag. Also, note that insertion of a benign tag does not change the document object model (DOM), which defines a standard way for accessing and manipulating a document according to a predefined format, such as an HTML format.

After rendering the text in the fragment shown in FIG. 4, additional data can be subsequently received and processed in the usual manner by the rendering engine 108. Note that it may also be possible that subsequently received data (following the fragment shown in FIG. 4) can also be an unclosed fragment. If that occurs, the fragment processing logic 110 can simply add another benign tag in the subsequently received unclosed fragment.

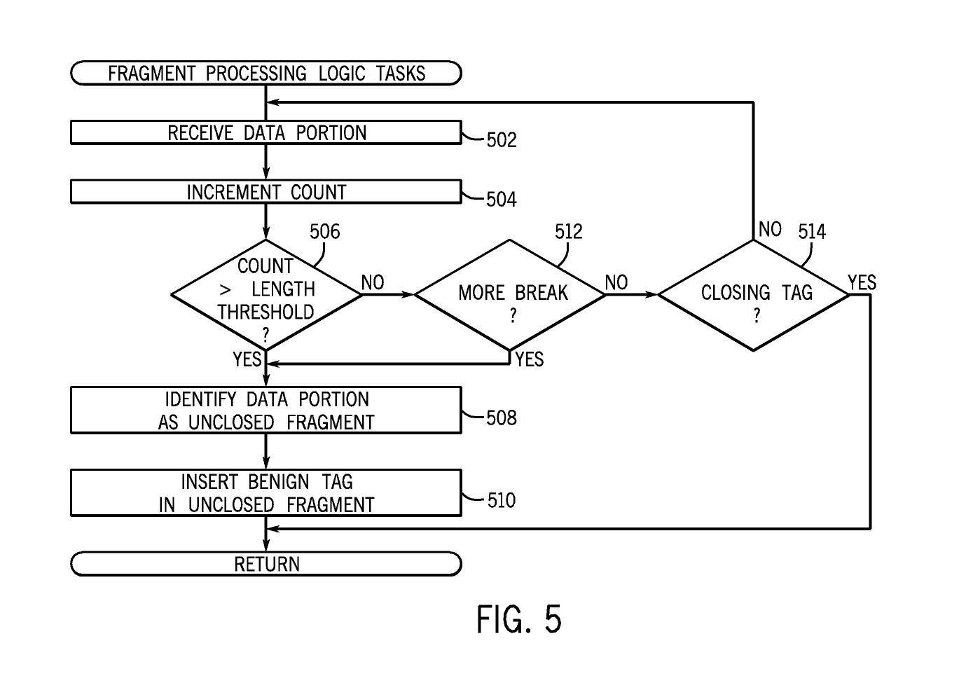

FIG. 5 shows a procedure to process received data by the fragment processing logic 110, according to alternative embodiments. The fragment processing logic 110 receives (at 502) a data portion to be rendered. With each received character (such as a text character) following an opening tag, the fragment processing logic 110 increments (at 504) a count of characters.

As noted above, in some scenarios, an unclosed fragment can be a fragment including a portion of content that exceeds a predefined length threshold. To detect such condition, the fragment processing logic 110 is configured to count a number of characters in the received data.

The fragment processing logic determines (at 506) if the count of the number of characters exceeds a length threshold. If the count exceeds the length threshold, then the fragment processing logic 110 identifies (508) the received data portion as an unclosed fragment. In response to such identification, the fragment processing logic inserts (at 510) a benign tag in the unclosed fragment (at a position of the unclosed fragment that is not within another tag or an entity, as discussed further below).

However, if the count of the number of characters does not exceed the length threshold, as determined at 506, the fragment processing logic 110 determines (at 512) whether a “more” break has been encountered. The “more” break is provided at the end of a first section of data (as sent by the server device 102) has been reached—the “more” break is an indication from the server device that there is further data not yet sent by the server device. Upon detection of the “more” break (or some other indication that the received data portion is partial data that is missing further data), the fragment processing logic 110 proceeds to tasks 508 and 510, to identify (508) the received data portion as an unclosed fragment and to insert (510) a benign tag in the unclosed fragment.

If a “more” break is not detected (at 512), then the fragment processing logic 110 determines (at 514) whether a closing tag (corresponding to the opening tag from which the fragment processing logic 110 started the count of characters) has been encountered. If not, then the process continues (at 502). However, if a closing character has been encountered (514), then the procedure of FIG. 5 returns. Note that the procedure of FIG. 5 is invoked again to process further received data.

As noted above, when inserting a benign tag, care is taken by the fragment processing logic 110 to ensure that the benign tag is not inserted in another markup language tag or inside a markup language entity. For example, FIG. 6 shows a paragraph, starting with <p>, that has text elements as well as the following markup language tags <em> and </em>, which are used to indicate that the text between this pair of tags should be emphasized (e.g. italicized). The fragment shown in FIG. 6 also includes a markup language entity &amp, which causes the ampersand symbol (&) to be rendered by the rendering engine.

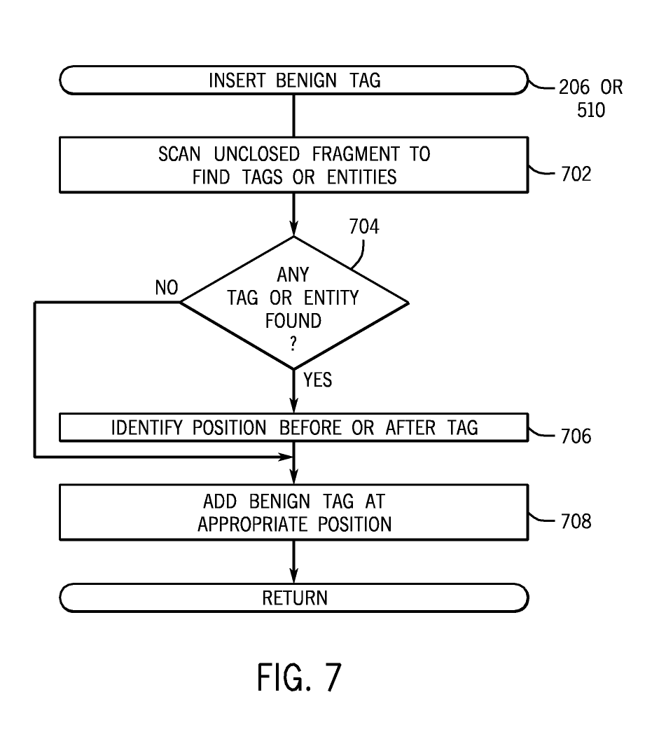

When a benign tag is to be inserted, the benign tag should not be inserted in either the tag <em> or </em>, or inside the entity &amp. FIG. 7 is a flow diagram of a process of inserting a benign tag (206 in FIG. 2 or 510 in FIG. 5), in accordance with some implementations. The fragment processing logic 110 scans (at 702) the unclosed fragment to find tags and entities. The fragment processing logic 110 determines (at 704) whether another tag or entity is found. If not, then the benign tag can be added (at 708), such as at the end of the unclosed fragment.

However, if another tag or entity was found, the fragment processing logic 110 identifies (at 706) a position before or after the other tag or entity. The benign tag is added (at 708) at this identified position.

To speed up the search for another tag or entity, the data portion can be scanned from its end. The search is sped up since only the last unclosed fragment has to be parsed by the fragment processing logic 110 to check for tags and entities. The ability of the fragment processing logic 110 to look for tags and entities to avoid inserting benign tags into such tags or entities assumes that the content is well-formed (meaning that the tags all match up, quotes all match up, and so forth).

In alternate implementations, instead of scanning the unclosed fragment to find another tag or entity, the fragment processing logic 110 can instead interact with the parser 108A (FIG. 1) of the rendering engine 108 to determine whether a currently parsed element (as parsed by the parser 108A) is a tag or entity. Such implementations assume that the parser 108A can be queried (such as by the fragment processing logic 110).

When the parser 108A encounters a “<” character, the parser 108A changes its state to “Tag open state.” If the fragment processing logic 110 determines, based on querying the parser 108A, that the parser 108A is currently in the “Tag open state,” then that is an indication that a benign tag cannot be inserted at the current position, as doing so would mean that the benign tag is inserted within another tag. The parser 108A stays in the “Tag open state” until the “>” character is consumed by the parser 108A, at which time the state of the parser 108A changes back to a “Data state.” The parser 108A encountering the “&” symbol would also cause the parser 108A to change its state from the “Data state” to a state that the parser 108A is parsing a markup language entity.

In accordance with some implementations, a fragment processing logic 110 is able to insert a benign tag when it receives a response from the parser 108A that the parser 108A is currently in the “Data state.” However, if the state returned by the parser 108A is a state indicating that the current position of the parsed content is within a tag or an entity, then the fragment processing logic 110 avoids inserting the benign tag.

By using techniques or mechanisms according to some implementations, unclosed fragments of received content can be properly rendered to enhance the user viewing experience.

Machine-readable instructions of modules described above (including the application 104, fragment processing logic 110, and rendering engine 108 of FIG. 1) are loaded for execution on processor(s) (such as 118 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method of a device having a processor, comprising:
receiving data to be rendered;
identifying a fragment in the data as unclosed, where the unclosed fragment is missing a closing tag corresponding to an opening tag of the unclosed fragment; and
in response to identifying the unclosed fragment, inserting a benign tag in the unclosed fragment to cause a rendering engine to render the unclosed fragment, wherein the inserting of the benign tag in the unclosed fragment is performed without inserting the closing tag corresponding to the opening tag of the unclosed fragment.

2. (canceled)

3. The method of claim 1, further comprising:
determining whether a condition relating to the fragment is satisfied,
wherein identifying the fragment as unclosed is in response to determining that the condition is satisfied.

4. The method of claim 3, wherein determining that the condition is satisfied comprises:
counting a number of characters in the fragment between a last tag of the fragment and an end of the fragment, and
detecting the number exceeding a predefined threshold.

5. A method of a device having a processor, comprising:
receiving data to be rendered;
determining whether a condition relating to a fragment in the data is satisfied;
identifying the fragment as being unclosed in response to determining that the condition is satisfied, wherein determining that the condition is satisfied comprises detecting a more break in the fragment: and
inserting a benign tag in the unclosed fragment to cause a rendering engine to render the unclosed fragment.

6. The method of claim 1, wherein inserting the benign tag comprises inserting a tag that is not recognized by the rendering engine.

7. The method of claim 1, further comprising:
checking for a markup language tag or a markup language entity in the unclosed fragment to avoid inserting the benign tag into the markup language tag or markup language entity.

8. The method of claim 7, further comprising checking for the markup language tag or markup language entity starting from an end of the received data.

9. The method of claim 7, wherein checking for the markup language tag or markup language entity comprises querying a state of a parser of the rendering engine.

10. The method of claim 1, further comprising:
during parsing of the unclosed fragment after insertion of the benign tag, detecting, by the rendering engine, the benign tag; and
in response to detecting the benign tag, rendering, by the rendering engine, the unclosed fragment.

11. The method of claim 10, further comprising discarding, by the rendering engine, the benign tag due to the benign tag being unrecognized by the rendering engine.

12. An article comprising at least one non-transitory machine-readable storage medium storing instructions that upon execution cause a device to:
receive a document containing content defined by a markup language;
identify a fragment in the content as unclosed, where the unclosed fragment is missing a closing tag corresponding to an opening tag of the unclosed fragment; and
in response to identifying the unclosed fragment, insert a benign tag into the unclosed fragment to cause a rendering engine to render the unclosed fragment, wherein the inserting of the benign tag in the unclosed fragment is performed without inserting the closing tag corresponding to the opening tag of the unclosed fragment.

13. The article of claim 12, wherein the content is defined by a Hypertext Markup Language.

14. The article of claim 12, wherein the instructions upon execution cause the device to further:
determine whether a condition relating to the fragment is satisfied,
wherein identifying the fragment as unclosed is in response to determining that the condition is satisfied.

15. The article of claim 14, wherein determining that the condition is satisfied comprises:
counting a number of characters in the fragment between a last tag of the fragment and an end of the fragment, and
detecting the number exceeding a predefined threshold.

16. The article of claim 14, wherein determining that the condition is satisfied comprises detecting a more break in the fragment, the more break indicating that the received data is partial data that is missing further data.

17. The article of claim 12, wherein the instructions upon execution cause the device to further:
check for a markup language tag or a markup language entity in the unclosed fragment to avoid inserting the benign tag into the markup language tag or markup language entity.

18. (canceled)

19. The electronic device of claim 20, wherein the identification of the fragment in the data as unclosed is based on one of:
a detection that a length of characters in the fragment exceeds a predefined length threshold; or
a detection that the received data including the fragment is partial data missing further data.

20. An electronic device comprising:
a network interface to receive data; and
at least one processor to:
receive the data to be rendered;
identify a fragment in the data that is unclosed; and
insert a benign tag in the unclosed fragment to cause a rendering engine to render the unclosed fragment, wherein the benign tag is a tag undefined by a markup language defining content of the received data.

21. The method of claim 1, wherein the benign tag has a “<” character and a “>” character.

22. The method of claim 1, wherein the benign tag is a tag undefined by a markup language defining content of the received data.

23. The method of claim 5, wherein the more break provides an indication that the received data is partial data that is missing further data.

24. The article of claim 12, wherein the benign tag is a tag undefined by the markup language defining the content of the received document.

25. The electronic device of claim 20, wherein the markup language is a Hypertext Markup Language.

26. The electronic device of claim 20, wherein the at least one processor is to insert the benign tag in the unclosed fragment, in response to identifying the unclosed fragment, without inserting a closing tag corresponding to an opening tag in the unclosed fragment.
